(19) United States
(12) Patent Application Publication
(10) Pub. No.: US 2014/0146731 A1
(43) Pub. Date: May 29, 2014

(54) SYSTEM AND METHOD FOR ESTABLISHING COMMUNICATION FOR NETWORK CONNECTED DEVICES

(71) Applicant: Cumbari AB, Stockholm (SE)

(72) Inventors: Harald Hynell, Stockholm (SE); Andreas Jönsson, Saltsjö-Duvnäs (SE); Ove Näslud, Älvsjö (SE); Kent Bogestam, Hägersten (SE)

(21) Appl. No.: 14/116,027

(22) PCT Filed: Apr. 26, 2012
(86) PCT No.: PCT/SE2012/000057

§ 371 Date: Nov. 6, 2013

(30) Foreign Application Priority Data
May 9, 2011 (SE) 1130035-7

(51) Int. Cl. H04W 4/00; H04W 52/02; H04W 76/02

(52) U.S. Cl. CPC H04W 4/008; H04W 76/023; H04W 52/0225
USPC 370/311; 370/338

(57) ABSTRACT

A method and a system for establishing communication among a plurality of network connected devices which are unaware of network and service addresses. The direct communication is facilitated by a network connected server device providing a common platform for a plurality of requesting devices to request a plurality of target devices by any means of initiation for a plurality of service attributes. The network connected server device has an intermediary function to make the system compatible with all means of initiation and wherein it is absent in service level communication of the devices.

### FIELD OF THE INVENTION

The present invention relates to a method and a system for establishing communication among a plurality of network connected devices. More particularly, the present method provides a method and a system for establishing a direct communication among a plurality of internet connected devices wherein the devices are unaware of each other's network addresses (IP address) and service address. The direct communication is established to generally perform a plurality of service attributes located on the same network.

### BACKGROUND OF THE INVENTION

Conventionally, internet connected mobile device could be used in a large number of business and personal relations where the aim is to communicate with a service on another device that is physically next to. Some of the examples of such device use could be:

a Point of Service (POS) in a store or on the street to which a user likes to present coupons, prove membership or make a payment (wherein the POS itself can also based on a mobile);

a device that a user desire to unlock and get access to;

a local phone system where the user desires to get connected using a personal device without knowing the identity (URI or MSIDN) of the connection;

a setup model for starting and moving control and interface to the user mobile for TV, Music device, radio, other home or local devices;

a model for moving control from device A to mobile to device B, for example a PC that wants to print on a printer;

‘I was/am here’ kind of services that gives the information that a user passed a certain location (logistics or voice message) or is waiting at a certain location (call me up or start service) etc.

Likewise, there could be enormous such situations wherein the devices in physical proximity need to communicate with each other. In most of these cases, usually it is only the human that knows about the availability of a service and that the devices are close to each other and therefore in such cases, human interruption is required for the transaction (e.g. payments and coupons), which is tedious and unwarranted.

The general problem is—How a physical device can request, on its own, another physical device to use its already existing network/internet connection to set up communication to perform a service request? The main reasons for this problem are that:
the devices are not aware of each other's existence;
the devices are not aware of each other's routable addresses;
the devices are not aware of any service request; and
there are often more than one requesting/requested devices making it unclear as to how to set up a common network connection.

Recently, a number of attempts have been made to solve the problem by using local networks such as Bluetooth® and InfraRed (IR), but the problem has been the lack of precision and versatility. In a queue to a POS where a person want to make a payment anyone in the queue can get connected to the POS and not only the person who wants to make a payment for example. If the connection is initiated by the mobile, the user can not be sure to which POS the user gets connected.

One attempt to solve this type of problem has been made by the European Computer Manufacturer's Association (ECMA) that developed a standard for near field communications, NFC1P-I (ECMA-340, ISO/IEC 18092) Near Field Communication Interface and Protocol. NFC is a short range wireless technology using magnetic field induction. Other standards such as ISO/IEC 14443 and FeliCa do partly try to solve the same problem. NFC and the RFID protocols can be set to have a maximum distance of 10 cm so that only one person at a time can be connected. This technology, however, requires a complete change of infrastructure, making it difficult for the technology to take off due to huge cost and investments. For example all mobile devices would need to support NFC networks and all POS would need to invest in new NFC reader/transmitter in order to create an infrastructure for a service. And even if the devices already have a network connection there, it is complicated for devices to setup a service with each other as the IP address is not known and it is not likely one would get the users to open a window on their mobiles and enter a IP and port number to set up the service connection.

There are a number of existing patents, standards and technologies, which attempts to solve the problems. Some of the relevant ones are enlisted below as:

International Patent Application No. PCT/US2008/054793 for patent application entitled ‘Data Exchange Initiated By Tapping Devices’. This patent application discloses an interface to set up NFC communication by tapping of devices and initiation of data exchange.

International Patent Application No. PCT/US2007/024634 for patent application entitled ‘System, Method And Apparatus For Communicating Information From A Personal Electronic Device’.

US Patent Application No. US20080046570, entitled ‘Web Format-Based Wireless Communications’.

http://v3.espacenet.com/publicationDetails/biblio?DB=EPODOC&a mp;adjacent=true&amp;locale=en EP&amp;FT=D&amp;date=20090213 &amp;CC=MX&amp;NR=2009001385A&amp;KC=A In general, a mobile device desires to set up communication to a service device that is physically next to it can do so by employing any of the initiation methods—which could be a Position based or ID based or any other method. A Position based model could use GPS, Base station triangulating, fixed position, WLAN SID or other methods to get the position. An ID tag based model would use RFID, Barcode, ID number, Camera etc. to determine the position. There could be several other methods using proximity data for initiation such as sound/noise etc. The initiation methods may vary from case to case and depending upon the availability and utility. These available technologies for short range communication, although tends to solve the general problem of setting up a local connection with the service provider, suffers with individual and holistic limitations of precision and compatibility. One major problem, common to all these technologies, is of compatibility with the existing platforms already in circulation and use—simply not all user devices are equipped with all these technologies for communication and not all service platforms are compatible to accept (receive and send) communication with all the technologies. Adoption of any of these technologies requires complete change of infrastructure, making it difficult for the technology to take off due to huge cost and investments. Furthermore, new and innovative methods and technologies for such short range communication kept on emerging, but they face the ‘take-off’ problem. Therefore, adoption of these technologies by manufacturers of personal electronic devices has been disappointing. Furthermore, it is very common that at POS, there are several mobile devices which intends to connect to the service device and they may like use different initiation methods; or alternatively there may be different user interface then the tap model, such as using barcode on the mobile device, sound signaling, member cards etc. It is difficult to set up infrastructure for all these technologies at the single POS. This is very costly and unviable option. There is no common model/protocol which allows communication compatibility for all these technologies on the common existing service platforms or even to accept any new technology which might come in future. Thus, it is desired to have a system which is devoid of such limitation while it being flexible enough to allow interoperability of these technologies to operate in parallel wherein the communication is established regardless of the technology employed for initiation or user interface.

The devices existing on a common network, such as internet or LAN (Local Area Network) or WAN (Wide Area Network) are unable to communicate to each other, even if they are in close proximity, unless they are aware of each other's network address. Thus, it is required to have a system for enabling communication among network connected devices in close proximity.

### OBJECTS OF THE INVENTION

The main object of the present invention is to provide a method and a system for establishing communication, which method/system overcomes some or all of the limitations associated with the prior art.

Accordingly, one of the objects of the present invention is to provide a method and a system which extends a common platform for setting up of a direct communication among a plurality of devices irrespective of the means of initiation employed.

Another object of the present invention is to provide a method and a system which is flexible enough to allow inter-operability of the communication devices, the means of initiation, and the service attributes wherein parallel communications are possible from independent and unknown devices approaching with different configurations for availing a different range of services.

Still another object of the present invention is to provide a system and a method which is not only cost-effective and easy to use but is also capable of providing a common platform for accepting all the existing technologies for initiation method as well as those which might be developed in future, so that there is minimal or no cost incurred in infrastructure development for its implementation.

Another object of the present invention is to provide a system and a method allowing the devices to find each other without manual input of network and/or service address.

Yet another object of the present invention is to provide a method and a system which allows for communication to be set up across firewalls and other communication obstacles.

The other objects and preferred embodiments and advantages of the present invention will become more apparent from the following description of the present invention when read in conjunction with the accompanying examples, figures and tables, which are not intended to limit scope of the present invention.

### STATEMENT OF THE INVENTION

The present invention provides a method for establishing communication among a plurality of network connected electronic devices in close proximity, wherein the devices may be unaware of each other's network addresses, the method comprising:
a. a requesting device stimulating a target device;
b. the requesting device and target device transmitting proximity data to a network connected server device;
c. the processing and comparing of the proximity data received by the server device from the requesting device and target device;
d. generation of peering information by the server device and transmitting of the peering information to requesting device and target device; and
e. peering of requesting device and target device using the peering information to establish a direct communication.

In addition to this, the present invention also provides a system for establishing communication among a plurality of network connected electronic devices, wherein the devices are unaware of each other's network addresses, the system comprising:
a. plurality of network connected electronic devices;
b. a means for stimulation of target device by requesting device; and
c. network connected server device for receiving, processing and comparing the proximity data and transmitting the peering data to individual devices.

These and other features, aspects and advantages of the present invention will become better understood with reference to the following description, preferred embodiments, examples and appended claims.

### F. BRIEF DESCRIPTION OF THE ACCOMPANYING DRAWINGS

FIG. 1. A basic overview of the method/system provided in accordance with the present invention.

FIG. 2. A diagrammatic view of a preferred embodiment of the present invention demonstrating a possible arrangement of communication among the requesting devices, target devices, server devices (DPS), service etc. inside the network.

### DETAILED DESCRIPTION AND PREFERRED EMBODIMENTS OF THE INVENTION

For the purposes of the present specification, the following abbreviations shall have the corresponding expansions and meanings:
RD—Requesting Device
TD—Targeted Device
DPP—Device Proximity Protocol
DPS—Device Proximity Service
POS—Point of Service
NFC—Near Field Communication

In accordance with the present invention, a network connected user device and a network connected service device, which are in close proximity to each other, are enabled to communicate each other by sharing information with a network server—Device Proximity Service (DPS), which is known directly or indirectly by the parties. The first device makes its presence felt to the other device in proximity by stimulating the other device by any of the initiation methods available. The initiation method is basically used to create something (proximity data) that can be shared with the DPS to enable a peered over the existing IP-connection by creating a new ID that the devices can share with any other service. Thus, upon stimulation, both the devices sends proximity information to the server DPS. The network server device DPS uses a Device Proximity Protocol (DPP) as a means to identify and process the proximity information to determine peering and sends back the peering information back to both the devices to set up communication (peering) among the network connected devices. Thus, to enable the communication setup, the DPP allows the parties to share information that the DPS can use to determine the device peering. Accordingly, more than one device can be peered by chaining the peering in this manner. The proximity information shared by the devices depends upon the initiation method used by the devices for stimulation and initiating communication. The peering information generated and transmitted by the DPS to the individual devices could be in the form of connection parameters such as protocols specific information including TCP, HTTP, port number or low end IP addresses. This peering information is used by the individual devices to set up direct communication with each other's network address. This DPS, therefore, can be seen as a DNS service for devices where the DNS address as input is replaced by proximity data that will return a DNS or IP address plus service to the parties.

After that the communication is set up it is up to the requesting service to handle the actual service delivery and the DPS is not involved in the service delivery itself. It is also up to the service or other parties on network or device for example to terminate the service.

The direction of the communication can go either way as for example a mobile device could wake up a POS and request a service or a door key service could wake up the key service on the mobile device that could prepare the service for the user to just fill in pin for example, if required.

On the device it is mostly an application performing a service that is the end point for the peering.

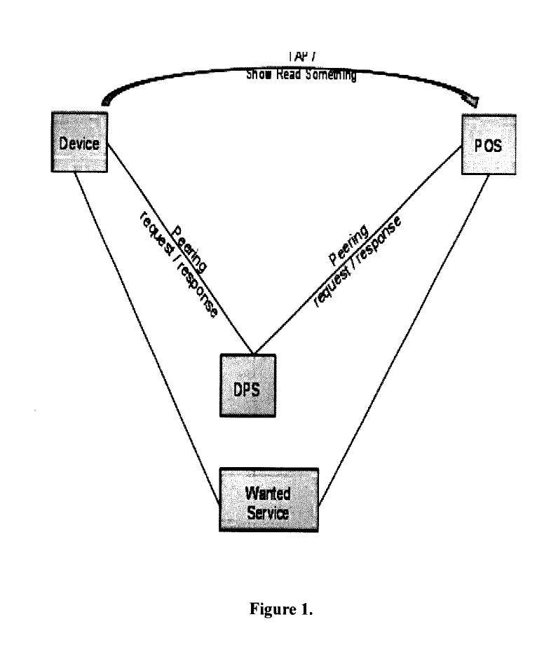

The basic overview of the model is provided in FIG. 1. The three step process is briefed as below:

Step one: Invoke the service with one of the initiation methods by taping the POS

Step two: The DPS finds a match based on the selected initiation method criteria and returns a peering ID valid for this peering

Step 3: If authorized the DPS returns a peering id to the involved parties that can be used to set up communication with the wanted service.

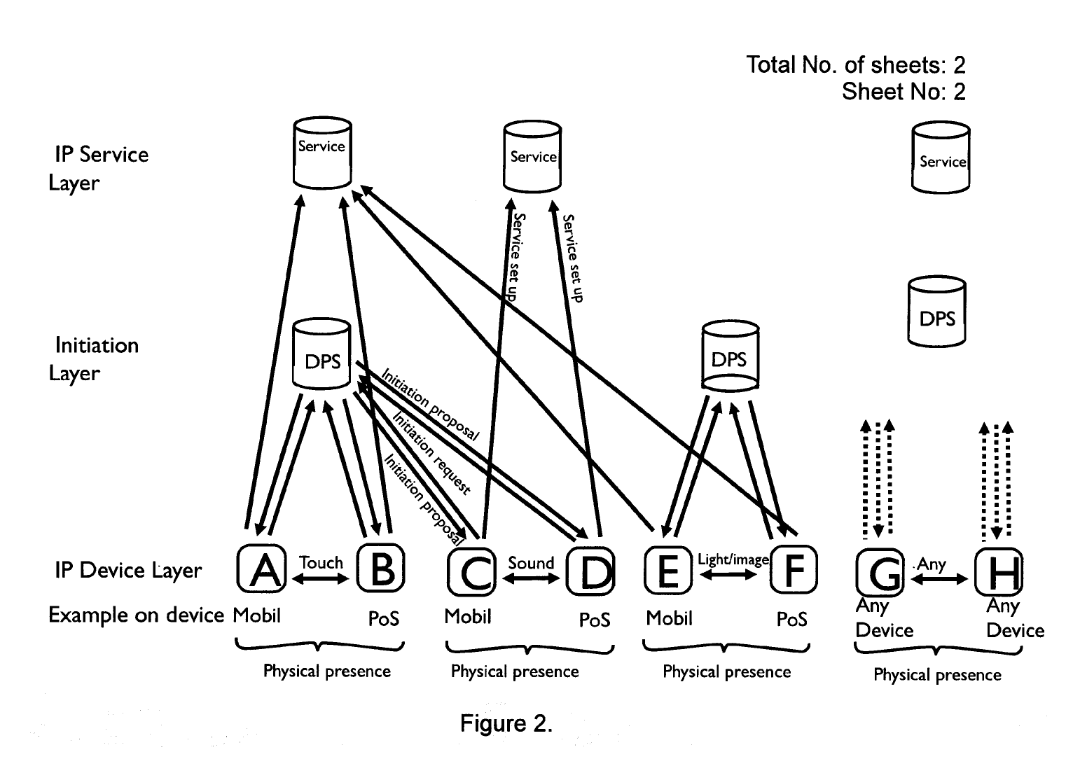

In accordance with one of the preferred embodiments of the present invention, there can be more the one DPS, they can be distributed based on service, region or other criteria. Also, there could be more than devices inter-communicating in parallel through the same or different DPS for same or separate service attributes. FIG. 2, without limitation, exemplify this embodiment by providing few configurations which can exist in accordance with the present invention.

In accordance with another preferred embodiment of the present invention, if the service device is off-line (no network connection) it may be requested to go on-line to set up the service by the service device and vice-versa.

In yet another embodiment of the present invention, the service itself may be based on the network or on one of the devices.

Set Up Models

The set up models in accordance with the most preferred embodiments of the present invention, without any limitation, are provided as below:

Service Model—The most common model for service set up is requesting a network based service that connects the devices into a temporary community service.

Chained Set Up—In accordance with this model, the tapped and tapping device requests chaining allows the DPS to wait for at least one more device to join connection to a number of devices into a temporary community service. The chain can also be established by letting device 1 and 2 connect to a service, then let the service connect device 1 and third device 3 that would transfer content to device 2. For example: Connecting a PC to a Printer where a mobile phone is used to activate the print service application, could follow the following steps: (a) Application requests the user to tap the device you like to print from with the mobile phone; (b) When the mobile phone taps the PC the mobile phone and PC sends request to DPS; (c) The service application gets peering ID from and the app on the PC gets the same Application say tap where you like to print; (d) Mobile tap Printer; and (e) PC print on printer.

Peer2Peer: Peer2Peer moves the service itself to one of the communicating devices so that the communication will end up in a peer2peer communication and removes the need for a network based services.

### Initiation Methods

Some of the initiation methods, which are used as preferred embodiments of the present invention are identified and described as below:

### Position Based Method:

In a position based method two or more device shows that they are on the same place at the same time.

A mobile client acting as Requesting Device (RD) taps on a pad at the Target Device (TD) and at the same time the client sends a setup Request using the DPP to the DPS. The pad sends a signal to the TD's application informing it that it has been touched. The application sends a setup Request using the DPP to the DPS. The setUp request may include supporting data that can be shared with the DPS to help the setup procedure.

The supporting data must include requested/requesting service direct or indirect position and may add local time difference to DPS, network, requested/wanted security level.

Based on this data and the time of the requests arrival the DPS decides with which RD that can be peered with. The DPS then informs the TD how to contact the chosen RD. TD adds a peering ID to the response that can be used by the parties to setup the wanted service without the involvement of the DPS.

The taping itself may be done by taping on a pad linked to the POS or place the device on the top of the tap pad and click on a button or by using any other physical device as tap pas as space bar button on a PC for example.

### Id Based Method:

In an id based method two or more device show to a DPS that they know each other's ID or has a common ID (by creating one) at the same moment. There are a number of ways to create ID that can be used to look up at a peering device.

Based on the ID and the time of the requests arrival, the DPS decides with which RD that the TD can be peered with in which TD ads a peering ID to the response. This ID can be used by the parties to setup the wanted service without the involvement of the DPS.

### Using RFID:

An RFID represents an ID where the RD is passed on to the TD RFID reader.

An application on the TD reads the ID. The application sends a setup request using the DPP to the DPS. The setup request may include supporting data that can be shared with the DPS to help the setup procedure. The supporting data must include requested/requesting service, RD device ID and own Device ID.

User Interfaces Other then the Tap Model
a. Using Barcode on the Mobile:

A barcode ID on the screen of a mobile device can represent an ID if the RD is displayed to the TD. An application on the TD reads the ID. The application sends a setup request using the DPP to the DPS. The setup request may include supporting data that can be shared with the DPS to help the setup procedure. The supporting data must include requested/requesting service, RD device ID and the ID derived from barcode.

b. Using Barcode Image the Targeted Device (POS)

A physical support frame (or some other detection service) in front of a 2D barcode on the targeted device act as an activator to send the setup request using the DPP to the DPS. The mobile takes a picture of the 2D barcode and sends (picture or analyzed result) using DPP to the DPS.

c. Using Sound Signaling

Target devices act as a microphone and records and forwards a sequence of sound signal (for e.g. a sequences burst of tone signaling that either a binary code or morse signaling) representing an ID sent by the requesting device (or the opposite direction). An application on the TD reads the ID. The application send a setup request using the DPP to the DPS and the requesting device is doing the same.

The setup request may include supporting data that can be shared with the DPS to help the setup procedure. The supporting data must include requested/requesting service, RD device ID and the ID derived from sound sequence.

d. Using an Additional Member Card or CC/DC

A member card ID or the ID of a Credit Debit Card is passed throw the reader (MSR) to the TD. An application on the TD reads the ID. The application sends a setup request using the DPP to the DPS. The setup request may include supporting data that can be shared with the DPS to help the setup procedure. The supporting data must include requested/requesting service, RD device ID and own Device ID.

e. Invoke a Service Device that is Off-Line

Out of power/resource saving some devices might be in a sleeping mode or off network mode e.g costly mobile network connections. If a device is off-line from the network at the time of the initiation it may be pre-configured to set up an IP connection. The device may be awoken by any of the previously proposed invocation interfaces as taping the service device may use a shock detection system to wake up the device and set up the IP connection or tap. For cases where shock detection is not appropriate it is possible to use sound signals, if a sound detection is available, to get a more explicit connection. If the device is awake but not connected any invocation model can be used to request the device to setup the IP connection.

The proximity data of the devices generally comprises the identification parameters of the devices, which are based on the initiation method employed for communication. The above mentioned initiation methods depicts only a representative set of known and widely used initiation methods. The selection of a particular initiation method does not in any manner limit the scope of the present invention and accordingly all such potential initiation methods, whether existing or later discovered, are included within the scope of the present invention.

Likewise, the means of stimulation of target device by a proximity action such as shock wave detection upon tapping, placing or holding one device on or close to the other device or recognition of sound signals or screening of a barcode on one device by another device are merely exemplary in nature and are not exhaustive. It is possible for the present invention to employ any other means of stimulation, whether presently known or not.

The client-server model, as depicted in several preferred embodiments above, is generally a distributed application structure for computing the partition tasks or workloads between the providers of a resource or service, called servers, and service requesters, called clients. Often clients and servers communicate over a computer network on separate hardware, but both client and server may, in a preferred embodiment, reside in the same system. A server is a host that is running one or more server programs which share their resources with clients. A client may not share any of its resources, but requests a server's content or service function. It is, therefore, the clients which initiate communication sessions with servers which await incoming requests.

### H. EXAMPLES

### Example 1

### Purchase in a Shop

When the user is about to pay, the users mobile is taped against the tap pad in front of the POS. Each device will send a setup request to a DPS. The DPS then returns a peering ID to the devices which pass it on to the involved services (payment provider, coupon provider, member card provider) to prove the peering partner.

The coupon service delivers coupons and member card service delivers the users member card to the cashier so that final price may be calculated The payment server can now get purchase info from the cashier and set up the secure transaction to the mobile, when the payment is secured the payment server communicates status back to the cashier and the mobile.

### Example 2

### Vending Machine

When the user wants to get something from the vending machine the users taps the mobile against the tap pad on the front of the vending machine. Each device will send a setup request to a DPS. The DPS returns a peering ID to the devices which pass it on to the involved services (Vending Machine Controlling Service) to prove the peering partner. The user can now use his mobile to get information about the content, select content and pay for the content

### Example 3

### Use Mobile as Secure Device When Making Bank Business

The user holds a certificate issued by the bank on his mobile device. When the user want to make a bank transaction and gets to the stage where an authentication is needed, the user simple hit the space bar on the PC (used as tap pad) with the mobile that holds the certificate to send a peering setup request to the DPS. The DPS returns a peering ID to the devices that then passes it on to the bank to prove the peering partner. The bank can now set up a secure channel to the mobile also and request authentication of the user. On successful authentication the transaction can be passed.

### Example 4

### Controlling Home Devices

When a user wants to set up a home device as a amplifier, the users taps the mobile against the tap pad on the front of the amplifier. Each device will send a setup request to a DPS. The DPS returns a peering ID to the devices which pass it on to the involved services (Amplifier Controlling Service) to prove the peering partner. The user can now use his mobile to control the amplifier.

### Example 5

### Game

Four kids want to play a network game. The first kid starts the game; the second and third kid taps the mobile of the first kid. The first kid leave the game and a fourth kid enters the game by taping the mobile of the third kid.

Although the present invention has been described in considerable detail with reference to certain preferred embodiments and examples thereof, other embodiments and equivalents are very much possible. Even though numerous characteristics and advantages of the present invention have been set forth in the foregoing description, together with functional and procedural details, the disclosure is illustrative only, and changes may be made in detail, especially in terms of the procedural steps within the principles of the invention to the full extent indicated by the broad general meaning of the terms in which the appended claims are expressed. Thus various modifications are possible of the presently disclosed method and system without deviating from the intended scope and spirit of the present invention. More particularly, the method as depicted in the present invention, is seemingly a simplified and generalized one and there are several trivial variations possible. Accordingly, in one embodiment, such modifications of the presently disclosed method of communication are included in the scope of the present invention. In addition to the method, there are functional variants of the presently disclosed system, all of which are included in the scope of the present invention.

1-29. (canceled)

30. A method for establishing communication among a plurality of network connected electronic devices in close proximity, wherein the devices may be unaware of each other's network addresses, the method comprising:
a. a requesting device stimulating a target device;
b. the requesting device and target device transmitting proximity data to a network connected server device;
c. the processing and comparing of the proximity data received by the server device from the requesting device and the target device;
d. generation of peering information by the server device and transmitting of the peering information to requesting device and target device; and
e. peering of requesting device and target device using the peering information to establish a direct communication.

31. A method as claimed in claim 30 wherein the said network is a private area network or the internet, preferably the internet.

32. A method as claimed in claim 30 wherein the said server device is not linked in the said direct communication among the requesting device and the target device.

33. A method as claimed in claim 30 wherein the said target device in a stand-by or power off mode is invoked upon stimulation by requesting device to attain service level for communication.

34. A method as claimed in claim 30 wherein the said stimulation of target device by the requesting device is by way of proximity action such as shock wave detection upon tapping, placing or holding one device on or close to the other device or recognition of sound signals or screening of a barcode on one device by another device.

35. A method as claimed in claim 30 wherein the said proximity data comprises the location parameters of the devices wherein geographical position or time on the devices or a combination thereof are compared to each other.

36. A method as claimed in claim 35 wherein the said location parameters are based on satellite positioning method or triangulation of regular base data from the phone network or local network data/tag such as Bluetooth, InfraRed or any IEEE 802.11 network.

37. A method as claimed in claim 30 wherein the proximity data comprises identification (ID) parameters of the devices wherein the identity and/or time on the devices or a combination thereof are compared to each other.

38. A method as claimed in claim 37 wherein the said identification parameters are based on short range communication protocols such as RFID tag or barcode ID or Near Field Communication (NFC) message or image recognition or sound signaling method or third devices identity such as a member card or credit card.

39. A method as claimed in claim 30 wherein the said method is used for chaining or peering three or more devices for direct communication with each other.

40. A method as claimed in claim 30 wherein the said direct communication between the requesting device and target device is to perform a plurality of service attributes requested by either of the device.

41. A method as claimed in claim 40 wherein the said service is hosted on any other device in the network and the devices are unaware of the addresses of the requested service.

42. A method as claimed in claim 40 wherein the said service is hosted on either the requesting device or the target device or any other device in direct communication with either of these devices.

43. A method as claimed in claim 30 wherein the said peering data is in the form of connection parameters, preferably protocols specific information such as TCP, HTTP or port number or low end IP addresses.

44. A system for establishing communication among a plurality of network connected electronic devices, wherein the devices are unaware of each other's network addresses, the system comprising:
a. a plurality of network connected electronic devices;
b. a means for stimulation of target device by requesting device; and
c. a network connected server device for receiving, processing and comparing the proximity data and transmitting the peering data to individual devices.

45. A system as claimed in claim 44 further comprising a plurality of service attributes located on the said network.

46. A system as claimed in claim 45 wherein the said service attribute is located on the requesting device or the target device.

47. A system as claimed in claim 44 wherein the said network is a private area network or the internet, preferably the internet.

48. A system as claimed in claim 44 wherein the said means for stimulation of target device is based on tapping, placing or holding one electronic device on or close to the other device or screening of a barcode or image or recognition of sound signals.

49. A system as claimed in claim 44 wherein the said network connected server device uses a Device Proximity Protocol (DPP) as a means to identify and compare the proximity data to determine peering and transmitting the peering data to individual devices.

50. A system as claimed in claim 44 wherein there are more than one devices requesting the same target device by same of different initiation method for same or different service attributes, thereby enabling establishment of multiple connections among a pair of devices simultaneously.
